(19) United States
(12) Patent Application Publication
(10) Pub. No.: US 2026/0363217 A1
(43) Pub. Date: Nov. 19, 2026

(54) A SYSTEM AND A METHOD FOR CONTROLLING THE POSITION OF A CAGE IN A BODY OF WATER

(71) Applicant: Elska Seafood AS, Bønes (NO)

(72) Inventors: Vidar Saue, Bønes (NO); Örvar Guõni Armarson, Vestmannaeyjar (IS)

(21) Appl. No.: 19/475,964

(22) PCT Filed: Apr. 23, 2024
(86) PCT No.: PCT/NO2024/050097

§ 371 Date: Oct. 16, 2025

(30) Foreign Application Priority Data
Apr. 26, 2023 (NO) 20230460
Nov. 27, 2023 (NO) 20231284

(51) Int. Cl. A01K 61/65

(52) U.S. Cl. CPC A01K 61/65

(57) ABSTRACT

A system for controlling the position of a submersible container (1) in a body of water (W) comprises a guide wire rope (66) or equivalent elongate guide member, extending between a support device (11; 13) and a ballast element (2; 2a) or anchor arranged on or near a seabed (B), and wherein the container (1) is configured for movement along the guide wire rope (66); an elongate support member (9; 67a, 67b), at a first end functionally connected to the container (1) and configured for restricting vertical movement of the container (1), and at a second end functionally connected to a support device (10; 27), and means (1 1; 68) for controlling the length of the elongate support member (9; 67a, 67b), wherein said means is releasably connected to the elongate support member (9, 67a, 67b). The system allows for controlling the vertical position of the submersible container (1) in a body of water (W).

### TECHNICAL FIELD OF THE INVENTION

The invention concerns the field of aquaculture. More specifically, the invention concerns a system comprising ropes, buoys and other equipment configured for controlling the depth of one or more underwater cage systems in a body of water, and associated methods.

### BACKGROUND OF THE INVENTION

Traditional fishfarming involves confining fish to net pens or cages floating in a body of water and feeding them specially manufactured, man-made, fish feed. Traditional fishfarming is associated with a number of undesirable consequences, such as poor fish welfare, local pollution, and the expenses and environmental impact of fish feed manufacturing. Other drawbacks of fishfarming in cages close to the water surface include fouling of nets, unstable water temperatures, water depleted of oxygen, parasites (like), jellyfish, and bacteria entering the cage. There is a need for a system that improves the existing technology, and in particular reduces the dependence on manufactured fish feed.

The prior art includes U.S. Pat. No. 4,744,331A, which describes a method and an apparatus for rearing fish in natural waters in a confined area by monitoring key criteria of the natural waters and monitoring the feeding and weight gain of fish. The apparatus comprises a cage for enclosing and maintaining the fish in a confined location in naturally occurring waters, means for feeding and culling the fish within the fish cage, means for monitoring water quality, weight gain and disease in each fish retained inside the cage, and means for retaining an air pocket within the cage. The cage may be placed at a desired—but preselected—depth in the water. However, the ability to change the depth of the cage may be important for many reasons, for example to escape copopods predators, increase or decrease amount of sunlight exposed to the cage, increase fish welfare by lifting cod up slowly without inflating the swimming bladder too much and to have the depth in swarms of zooplankton for feeding.

There is thus a need for a system whereby the depth of a submerged cage may be controlled in more efficient manner.

### SUMMARY OF THE INVENTION

The invention is set forth and characterized in the main claim, while the dependent claims describe other characteristics of the invention.

It is thus provided a system for controlling the position of a submersible container in a body of water, characterized by:
said container;
a guide wire rope or equivalent elongate guide member, extending between a support device and a ballast element or anchor arranged on or near a seabed, and wherein the container is configured for movement along the guide wire rope;
an elongate support member, which at a first end is functionally connected to the container and configured for restricting vertical movement of the container, and at a second end is functionally connected to a support device, and
a control assembly for controlling the length of the elongate support member between the support device and the container.

In one embodiment, the control assembly comprises a support platform arranged on the support device and a stopper device releasably connected to the elongate support member, and the container and the stopper device are arranged at opposite sides of the support platform, whereby the container is supported by the support device when the stopper device is supported by the support platform.

In one embodiment, the control assembly comprises:
a support platform arranged on the support device and a least one stopper device releasably or permanently connected to the elongate support member, and wherein
the support platform comprises a channel configured and dimensioned for allowing the elongate support member and the stopper device to pass, and
the support platform comprises a device configured for extension into and retraction from the channel, and the device is dimensioned and configured to prevent the stopper device from passing through the channel. The device may comprise at least one plunger.

In one embodiment, the support platform comprises a magnetically operated solenoid configured for operating the at least one plunger, at least one magnetic sensor configured for sensing a magnetic field in the channel, and the a least one stopper device comprises a magnetic material, wherein the support platform is configured to operate the solenoid when the at least one sensor detects the presence of the a least one stopper device inside the channel. The support platform may comprise a timer configured for controlling the operation of the solenoid.

In one embodiment, the elongate support member at the first end comprises a ballast member which is configured and arranged for releasable abutment against a portion of the container, and the container has positive buoyancy.

In one embodiment, the container is a submersible fish cage having a net and upper and lower support members and a plurality of intermediate members, and an upper module. In one embodiment, the elongate support member is a rope or wire or an electricity and communications cable.

In one embodiment, the guide wire rope extends beyond the support device and is connected to a surface buoy.

In one embodiment, the elongate support member comprises a first portion and a second portion that are relaseably connectable via a connector arranged on a mooring rope.

In one embodiment, the system comprises a locking device located on the top or the bottom of the container and comprising a rack housing and a pinion housing, wherein two pinion members are rotatably connected to the pinion housing, and two wedge-shaped rack members are connected to the rack housing, and each pinion member comprises a wheel member and a set of pinion gears on either side of the wheel member, wherein one or more electromagnets are arranged above the pinion housing, and one or more corresponding magnetic members are arranged on top of the pinion housing, and the guide wire rope runs through the locking device, wherein when the container is lifted and at least one electromagnet is activated, the pinion housing is lifted whereby the container is not attached to the guide wire rope and may be moved up or down along the guide wire rope, and; wherein when the at least one electromagnet is deactivated, the pinion housing is released from the track housing and is allowed to fall downwards such that the wedge-shaped rack member will force the two pinion members towards each other and cause the respective wheel member to bear against opposite sides of the guide wire rope and thus fixing the locking device against the guide wire rope.

It is also provided a method of controlling the vertical position of a submersible container in a body of water, by means of the system according to the invention, characterized by:
lifting a stopper device so that it is not supported by the support platform;
repositioning the stopper device on the elongate support member, and
lowering the stopper device until it is supported by the support platform.

In the method, the stopper device is lifted and lowered while it is attached to the elongate support member, and the lifting and lowering is performed by a crane connected to the elongate support member.

It is also provided another method of controlling the vertical position of a submersible container in a body of water, by means of the system according to the invention, characterized by:
arranging the submersible container in a body of water and connecting it to the guide wire rope;
connecting a mooring rope between the support device or the guide wire rope in a vicinity of the support device and a surface support device or other surface facility;
connecting an electricity and communications connector to the mooring rope;
connecting a first elongate support member portion between a system module and the connector;
connecting a second elongate support member portion between the connector and the container;
disconnecting the second elongate support member portion from the connector and connecting it to the surface support device; and
raising or lowering the second elongate support member portion to control the vertical position of the container in the body of water.

### BRIEF DESCRIPTION OF THE DRAWINGS

These and other characteristics of the invention will become clear from the following description of embodiments of the invention, given as non-restrictive examples, with reference to the attached schematic drawings, wherein:

FIG. 1 illustrates a first embodiment of the invented system, installed in a body of water;

FIG. 2 illustrates a variant of the first embodiment of the invented system, installed in a body of water;

FIG. 3a illustrates an embodiment of a buoyant support device and an embodiment of a stopper device, showing the stopper device in a non-engaged state, while FIG. 3b illustrates the stopper device and the buoyant support device in an engaged state;

FIGS. 4a, 4b, 5a, and 5b illustrate steps in a depth adjustment procedure for the first embodiment of the invented system;

FIGS. 6a and 6b illustrate a variant of the first embodiment of the invented system, at two different depths in the body of water;

FIG. 7 is a perspective view of an embodiment of a support platform according to the invention;

FIGS. 8, 9, 10a, and 10b are cross-sectional drawings of the support platform illustrated in FIG. 7, in different operational modes;

FIGS. 11, 12, and 13 illustrate a second embodiment of the invented system, installed in a body of water, and an associated depth adjustment procedure;

FIG. 14a is a perspective view of a locking device, FIG. 14b is a perspective view of a pinion member, and FIG. 14c is a perspective view of a rack member;

FIGS. 15a and 15b are perspective views of a rack housing and a pinion housing, respectively, of the locking device illustrated in FIG. 14a;

FIGS. 16 and 17 are side view sketches showing the locking device illustrated in FIG. 9a in an inactivated position and an activated position, respectively;

FIGS. 18 and 19 illustrate the locking device in relation to a cage member and a central member;

FIGS. 20, 21, and 22 illustrate yet another embodiment of the invented system, installed in a body of water, and an associated depth adjustment procedure; and

FIGS. 23a and 23b are perspective views from above and below, respectively, of an embodiment of a magnetic support member.

### DETAILED DESCRIPTION OF EMBODIMENTS OF THE INVENTION

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting.

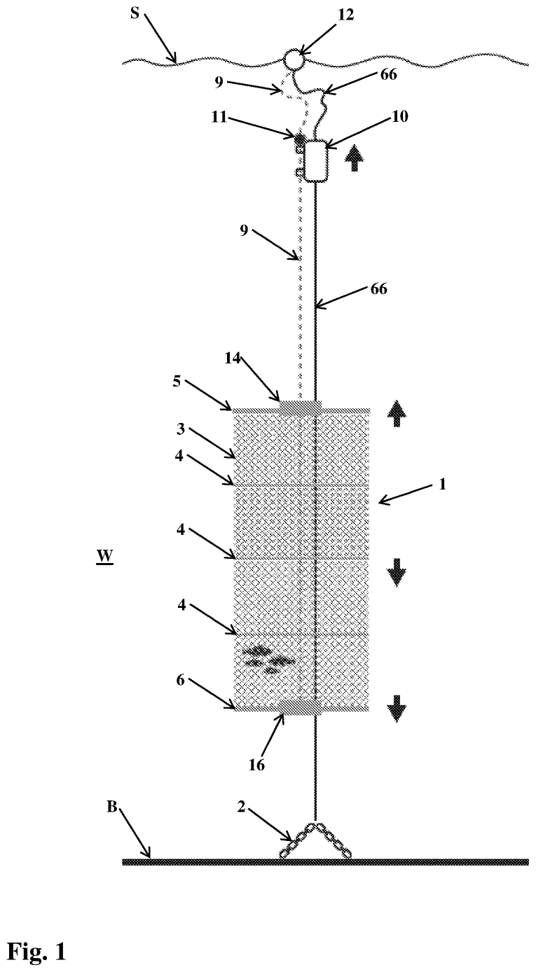

A first embodiment of the invented system and method will now be described with reference to FIGS. 1 to 5. Referring initially to FIG. 1, a fish cage 1 is submerged in a body of water W and suspended by a support rope 9, which may be a wire rope, synthetic rope, a cable, or similar. The support rope 9 is connected to a support device. In the illustrated embodiment the support device is a buoyant support device 10 and the support rope 9 is connected to the buoyant support device via a stopper device 11, as will be described below. In the illustrated embodiment, the buoyant support device 10 is a buoy arranged below the water surface S and tethered to the seabed B via a guide wire rope 66 connected to a ballast element or anchor 2 at or near the seabed. The guide wire rope 66 is maintained taut by virtue of the buoyancy provided by the support device 10. The fish cage I may be any submersible fish cage known in the art. Although not illustrated, it should be understood that the cage may comprise lights, feeding systems, power supply, an air dome, and other required life support systems. In the illustrated embodiment, the cage 1 is a net cage with a net 3 having a mesh width dimensioned for retaining the fish to be farmed, but allowing smaller organisms, such as plankton, and particles to pass through. The cage 1 comprises an upper support member 5 and a lower support member 6. In the illustrated embodiment, the upper and lower support members 5, 6 are ring members. The upper support member 5 preferably has a positive or neutral buoyancy, and the lower support member 6 preferably has a neutral or negative buoyancy. A plurality of intermediate members 4, for example ring members, are arranged between the upper and lower support members 5, 6. The members 4-6 serve to hold the net 3 in the desired shape (e.g. cylindrical), in a manner well known in the art. However, the cage 1 may have other shapes, for example that of a cylinder, an octagon, a cube, or a sphere. In the embodiment illustrated in FIG. 1, the cage has a net negative buoyancy.

An upper module 14 is arranged at the top of the cage, and is connected to power and control devices (not shown) in or via the surface facility 12. The upper module 14 may be connected to the upper support member 5, directly or indirectly. The upper module 14 is structurally connected to the surface facility 12 via the support rope 9, which may comprise a rope or/and a cable and is dimensioned such that it is capable of supporting the cage, in and above the water, and may additionally comprise cables, wires, and/or conduits for controlling systems in the cage, transmitting electrical signals, and for supplying electrical power to the cage. The surface facility 12 may comprise a buoy or a platform and be moored to the seabed in a manner known in the art. Although not illustrated, it shall be understood that the cage may be furnished with sensors, cameras and other monitoring and control devices, as are known in the art. A lower module 16 is arranged at the bottom of the cage. In the illustrated embodiment, the support rope 9 extends through the cage and is structurally connected to the lower module 16. The support rope 9 may be fixed to the upper module 14 or may be arranged to slide with respect to the upper module. The support rope may also be connected only to the upper module or another part of the cage, all depending on the cage type (e.g. rigid or flexible and collapsible).

In the illustrated embodiment, the guide wire rope 66 extends through the cage 1 and is movably (e.g. slidably) connected to upper 14 and lower 16 modules. The cage may thus be moved up and down in the water (for example as controlled by the support rope 9), guided by the guide wire rope 66. It should be understood that the guide wire rope may be movably connected to the cage by other means and at other cage positions, as long as the guide wire rope serves the intended purpose of guiding the cage when it is being elevated or lowered. The support rope 9 and the guide wire rope 66 are preferably spaced apart in order to mitigate tendencies to cage rotation around the support rope.

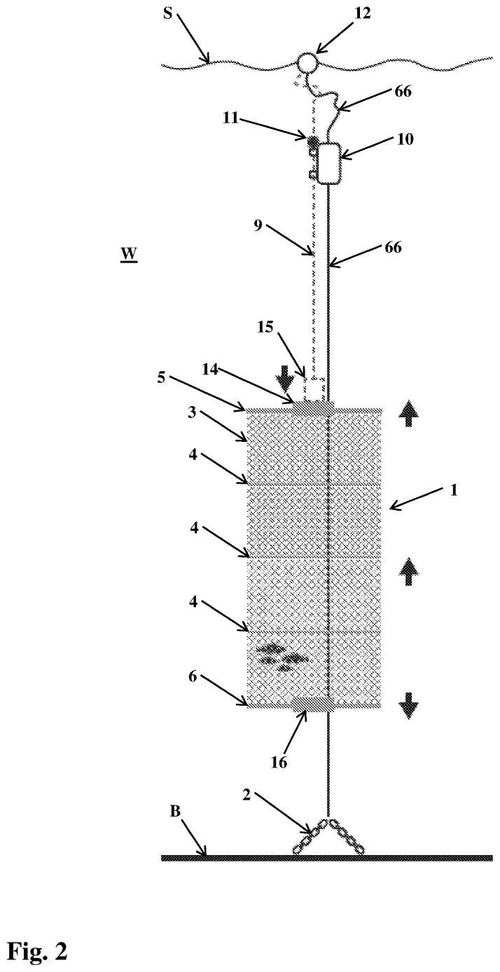

FIG. 2 illustrates a variant of the embodiment described above with reference to FIG. 1, with the exception that the support rope 9 is not structurally and permanently connected to the cage 1, but instead to a ballast member 15, and that the cage 1 has a net positive buoyancy. In FIG. 2, the ballast member 15 is resting on the cage 1, and the weight of the ballast member 15 balances the buoyancy of the cage. The cage may thus be maintained at a desired depth by dimensioning the ballast member weight and length of support rope with the cage buoyancy.

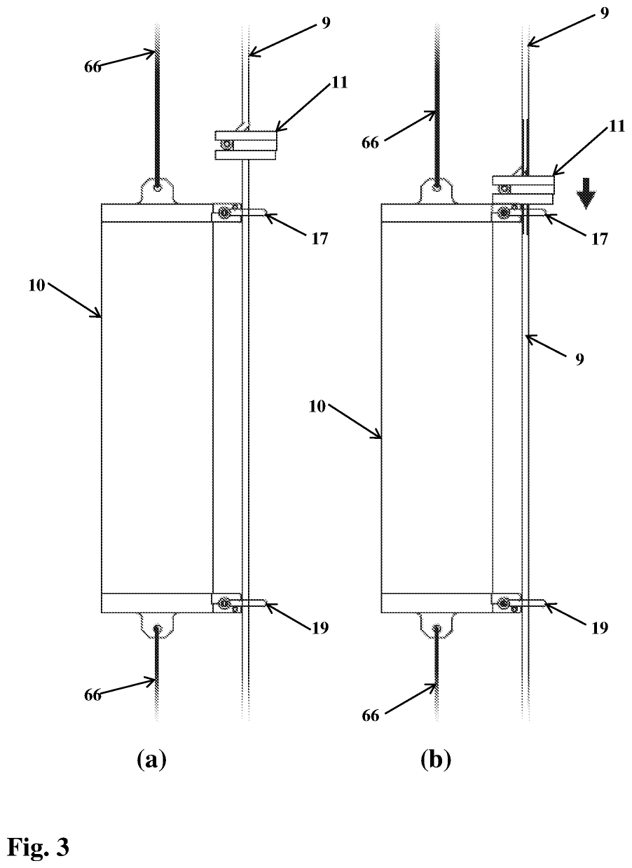

Referring to FIGS. 3a and 3b, the support device 10 comprises in one embodiment a buoyant body having an abutment member 17 through which the support rope 9 is arranged, and a lower support rope guide 19. The stopper device 11 is releasably connected to the support rope 9 in a manner known in the art, and may for example be a clamp or a knot on the rope itself. The abutment member's 17 internal dimension (through which the support rope is passing) is smaller than the size of the stopper device 11, such that the stopper device 11 cannot pass through the abutment member 17.

Therefore, when the stopper device 11 is resting on the abutment member 17, the abutment member functions as a support platform and the cage 1 is supported by the support device 10 and will be maintained at the desired depth in the water. It will be understood that the support device 10 in the illustrated embodiment generates a buoyant force that is sufficient for supporting the cage 1.

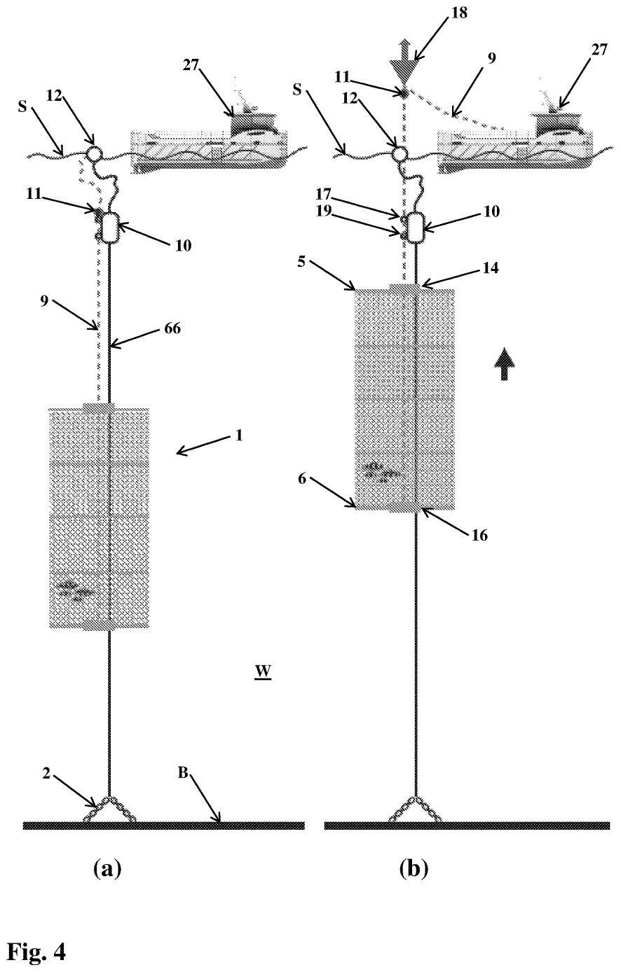

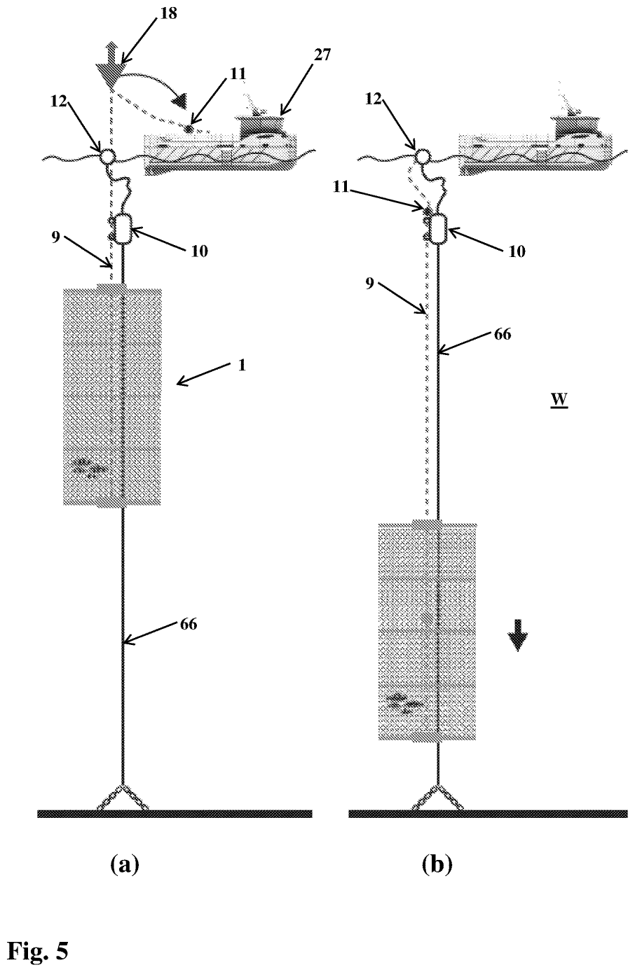

The depth of the cage 1 in the water may thus be controlled by arranging and attaching the stopper device 11 at a desired position on the support rope 9. A procedure for changing the depth of the cage 1 is illustrated in FIGS. 4a, 4b, 5a, and 5b.

In FIG. 4a, the cage 1 is arranged a first water depth, suspended as described above. In FIG. 4b, the support rope 9 has been pulled up by a crane 18, winch, or other lifting device arranged on a vessel 27 or other support structure, such that the stopper device 11 is accessible for being released from the support rope 9 and reattached at another location on the support rope 9. FIG. 5a illustrates how the cage 1 is lowered into the water, and FIG. 5b illustrates how the cage has come to rest at a second water depth.

The system module may be powered by a power cable from an onshore facility or/and may comprise a power generation-and-storage system, as well as a power and signal distribution system for individual cages.

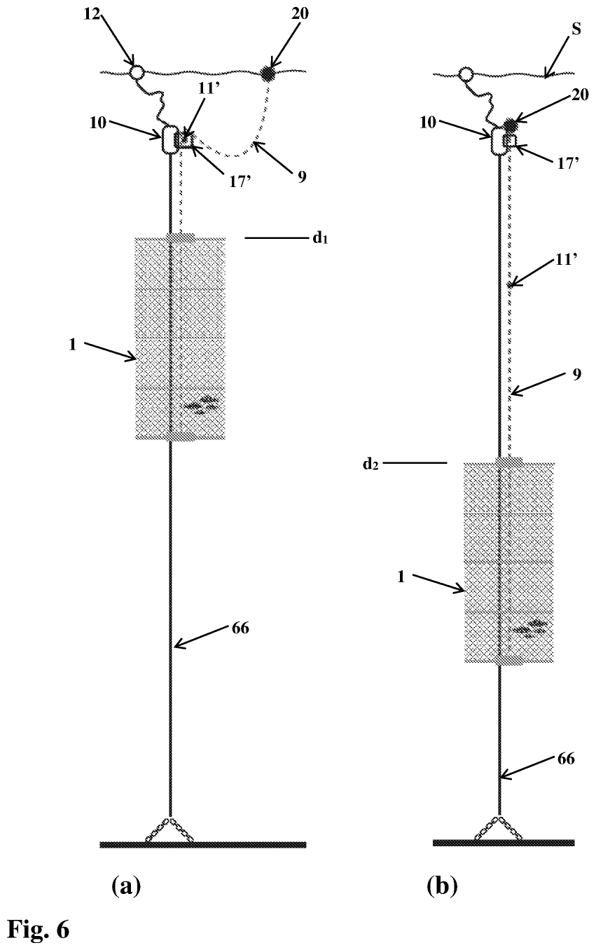

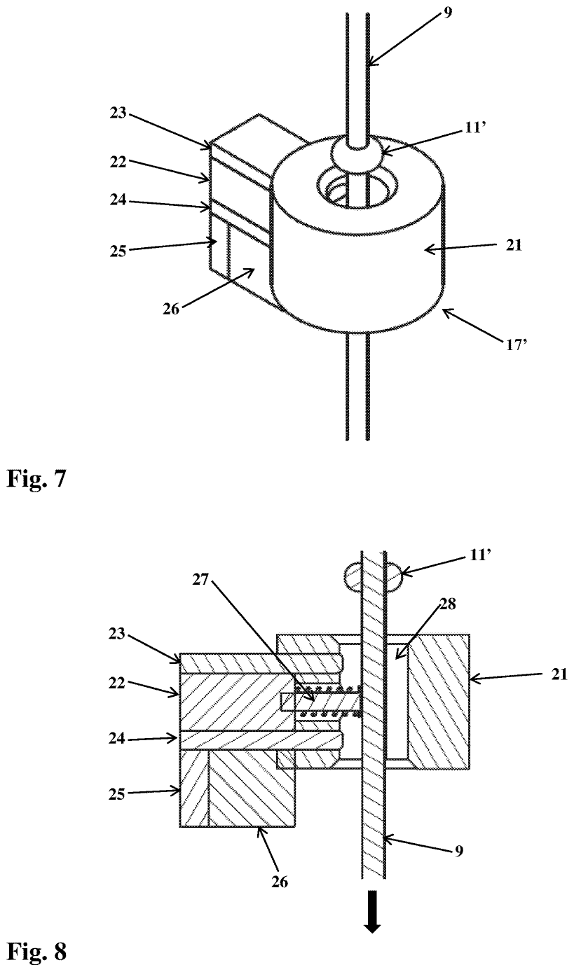

A variant of the first embodiment as described above will now be described with reference to FIGS. 6 to 10. Initially referring to FIGS. 7 and 8, the abutment member 17′ (also referred to as a support platform 17, described above), comprises a support body 21 which is attached to the support device 10 in the same manner as the support platform 17. (However, the physical connection between the support body and the support device 10 is not illustrated in FIGS. 7 and 8). The support body 21 comprises a through-going opening 28 that allows passage of the support rope 9 and the stopper device 11′.

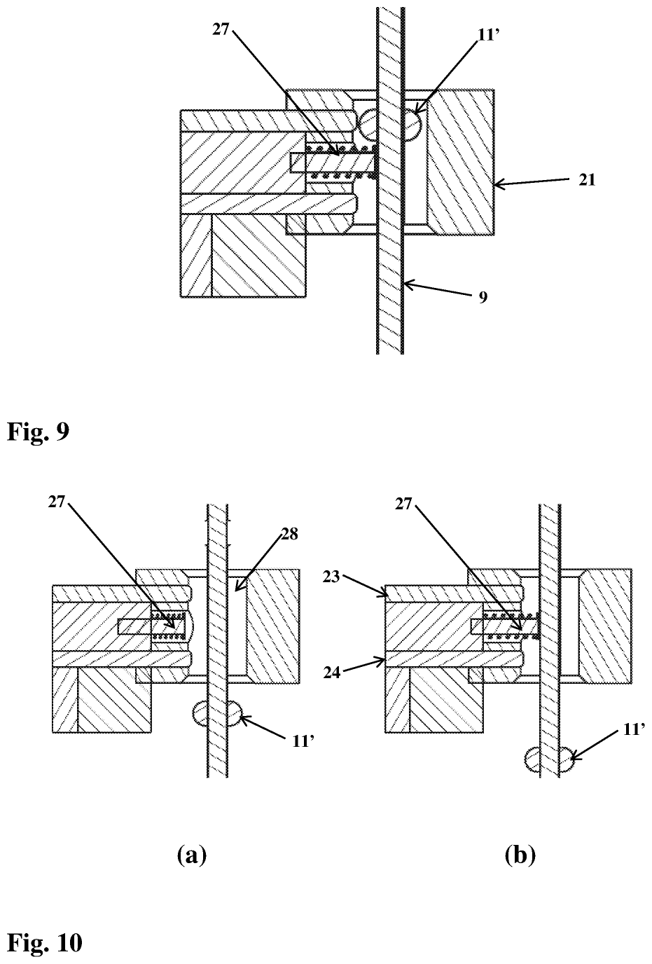

A plunger 27 is arranged in the abutment member 17′ for reciprocating movement into the opening 28, between a retracted position, (see FIG. 10a) and an extended position (see e.g. FIG. 8). When the plunger 27 is in a retracted position it is not extending into the opening 28, and the stopper device 11′ may pass freely. However, when the plunger 27 is in an extended position, it extends into the opening 28 and prevents the stopper device 11′ from passing through the opening. In this position-illustrated in FIG. 9 the plunger 27 is in fact supporting the cage by virtue of the abutment between the stopper device 11′ and the plunger 27. It should be understood that the parts and components described above comprise materials of sufficient strengths for the intended purpose. It should also be understood that the abutment member 17′ may comprise several plungers 27 or corresponding retractable abutment members, for example arranged circumferentially around the through-going opening 28. The plunger may be remotely controlled by means of devices known in the art, or may be controlled by automated procedures as described below.

In the illustrated embodiment, the plunger 27 is a spring-loaded plunger, biased towards the extended position. The plunger is thus releasably and controllably retained in the retracted position. In the illustrated embodiment, the spring-loaded plunger 27 is releasably and controllably retained in the retracted position by means of a magnetically operated solenoid 22 which is controlled by a first magnetic sensor 23 and a second magnetic sensor 24, arranged at opposite sides of the solenoid 22, and arranged for sensing a magnetic field in the through-going opening 28. It should be understood that the plunger may be operated by other devices.

In the illustrated embodiment, the stopper device 11′ comprises a magnetic material that generates a magnetic field of a strength sufficient for the magnetic sensors to sense it when the stopper device is adjacent the respective senor.

FIG. 8 illustrates a situation in which the plunger 27 is in an extended position (e.g. the magnetically operated solenoid 22 is not activated), and the support rope 9 with the stopper device 11′ affixed to it, moves downwards as indicated by the arrow. This configuration may be consistent with lowering the cage in the water, as described above. FIG. 9 illustrates that the plunger prevents the stopper device 11′ from passing through the opening. In FIG. 10a, the plunger has been retracted, allowing the stopper device 11′ to pass, whereafter the plunger again may be released (FIG. 10b).

The cage may thus be positioned at a desired water depth, determined by the location of the stopper device 11′ on the support rope 9. Although not illustrated, it should be understood that support rope 9 may comprise several stopper devices 11′, connected at different positions along the rope.

In operation, the cage may be lowered into the water, by virtue of its inherent negative buoyancy, until the downward movement is arrested by the interaction between the plunger 27 and the support device 11′, as illustrated in FIG. 9. This state is also illustrated in FIG. 6a. Following a desired time period, the plunger is retracted such that the support device 11′ is allowed to pass, for example by means of the solenoid 22, and the cage sinks even further, until an end stopper 20 (see FIG. 6b) on the support rope 9 reaches the support platform 17′. The end stopper 20 is wider than the through-going opening 28, so the cage is now supported by the end stopper.

The interaction between the two magnetic sensors 23, 24, the solenoid 22, and the magnetized stopper device 11′ may be used to change the cage's position between different water depths. In general, the support platform 17′ may be operated or configured to operate such that the solenoid 22 receives a command to retract or release the plunger 27 when a magnetic sensor 23, 24 senses the stopper device 11′ For example, if the intention is to lower the cage to a first water depth di (see FIG. 6a), the plunger 27 is released when the first magnetic sensor 23 senses the presence of the stopper device 11′. This is illustrated in FIGS. 8 and 9. If the intention is to lower the cage further, to a second (deeper) water depth d₂ (see FIG. 6b), the plunger 27 is retracted, allowing the stopper device 11′ to pass through the opening 28 until the downward movement is arrested by the end stopper 20 abutting against the support platform 17′. In the illustrated embodiment, the support platform 17′ comprises a power supply 26 (e.g. a battery) and a timer 25, by means of which the solenoid may be operated. For example, if it is desirable to maintain the cage at the first depth di before lowering it to the second depth d₂, the timer 25 may be configured to activate the solenoid 22 and retract the plunger 27 after a predetermined duration. This function is useful for changing the cage depth in steps, such that vital organs in fish inside the cage are given time to adjust to the pressure changes. For example, the timer 25 may be set to maintain the cage 1 at the first depth di for twelve hours before allowing the lowering to proceed.

When the cage 1 is being lifted, the second sensor 24 senses the stopper device 11′ on its way up, sends a signal to a control module (not illustrated) which activates the solenoid 22 to retract the plunger 27 (for example as illustrated in FIG. 10a), allowing the stopper device 11′ to pass the plunger. The plunger is then released to provide support for the stopper device 11′ (for example as illustrated in FIG. 9). In one embodiment, the cage is lifted by adding weight to the end stopper 20 and moving it off of the support device 10 such that it sinks deeper into the water. The downward movement of the end stopper 20 causes the cage to rise in the water.

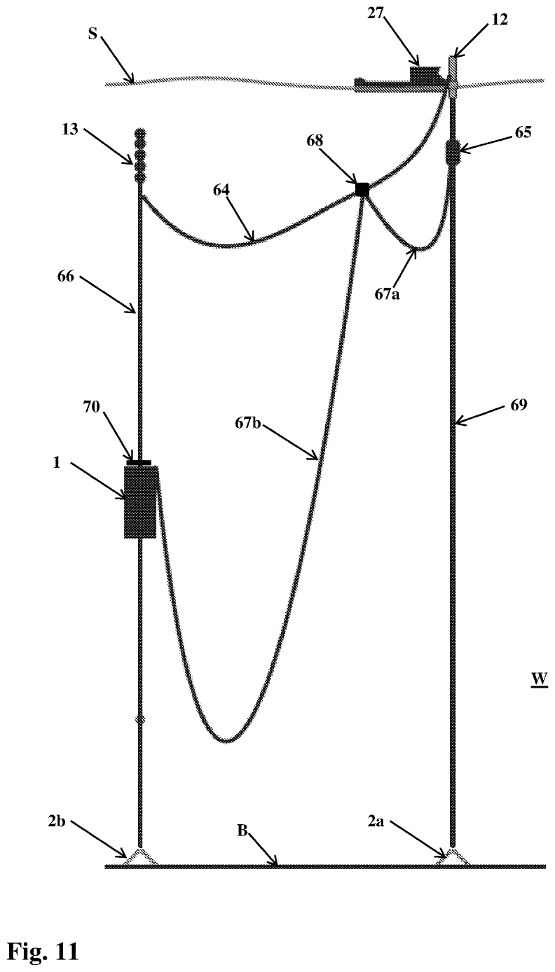

A second embodiment of the invented system and method will now be described with reference to FIGS. 11 to 13, which are schematic illustrations of a guidewire system and an associated cage installation sequence. A system module 65 is submerged in the water, connected to the seabed via a tether 69 and a first ballast element or anchor 2a, and connected to a surface buoy 12. The system module may be powered from a remote facility, such as an onshore grid, or comprise an onboard power supply. Power is transmitted from the system module to the cage. The system module comprises means for signal communication with the surface facility (e.g. a buoy) 12. Several cages may be connected to a single surface buoy and system module.

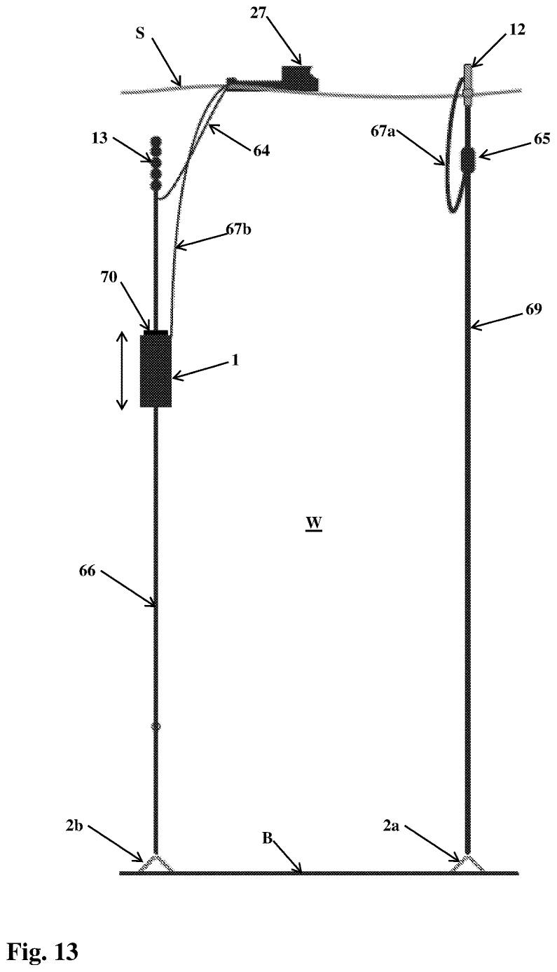

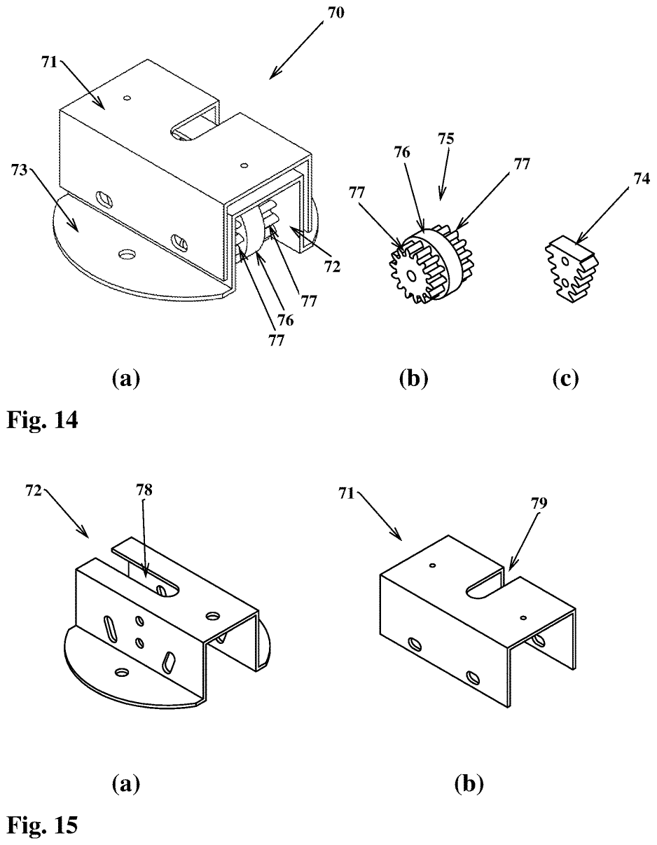

In FIG. 11, the cage 1 has been installed in the body of water W and is connected to a guide wire rope 66. The guide wire rope 66 is tethered to the seabed via a second ballast element 2b or anchor a lateral distance away from the system module 65 and maintained taut by one or more buoyancy devices 13. The fish cage 1 is movably connected to the guide wire rope 66 and may move up and down in the water along the guide wire rope, as indicated by the double arrow in FIG. 13 and explained below. The cage may be fixed with respect to the guide wire by means of a locking device 70, an example of which is described below with reference to FIGS. 14 to19.

In FIG. 11, a mooring rope 64-which has been used for installing the cage-and-guide wire rope assembly-is attached to the guide wire rope above the cage and connects the guide wire rope to the surface buoy (communications buoy) 12. A first electricity and communication cable 67a extends between the system module 65 and a connector 68 on the mooring rope 64, and a second electricity and communication cable 67b extends between the connector 68 and the cage 1.

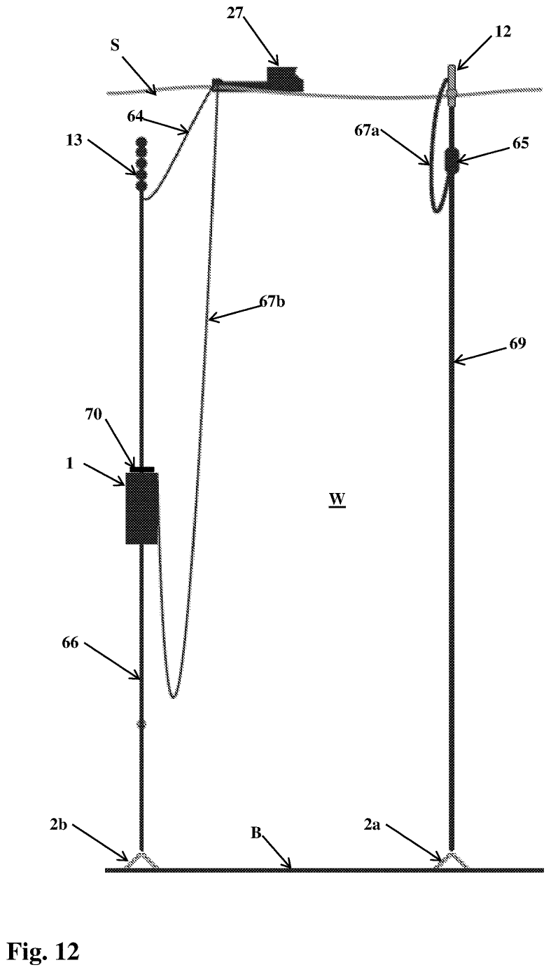

In FIG. 12, the second electricity and communication cable 67b has been disconnected from the connector 68 and attached to a ship (or other surface vessel or structure) 27, and the first electricity and communication cable 67a has been connected to the surface buoy 12. The mooring rope 64 has also been connected to the ship 27, and is reeled in as the ship approaches the buoyancy devices 13. FIG. 13 illustrates how the cage 1 may be moved up and down along the guide wire rope 66 by adjusting the length of the second electricity and communication cable 67b. The cage 1 may thus be placed at a desired water depth.

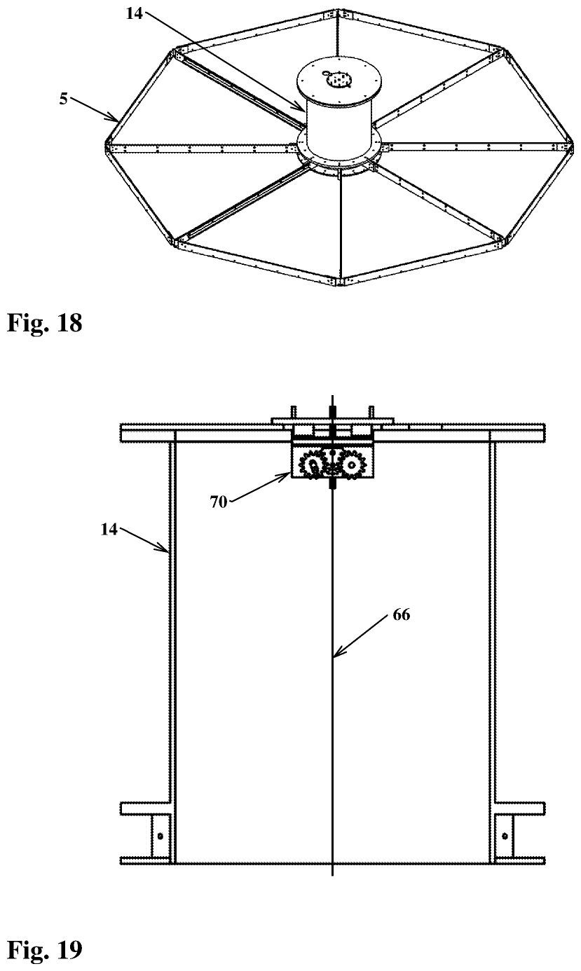

The locking device 70 may be any suitable device known in the art. A preferred embodiment of a locking device 70 will now be described with reference to FIGS. 14-19. The locking device 70 comprises a rack housing 72 and a pinion housing 71. The locking device 70 is in the illustrated embodiment located in the above-mentioned upper module 14 on the top of the cage, as illustrated in FIGS. 18 and 19. Two pinion members 75 are rotatably connected to the pinion housing 71, and two wedge-shaped rack members 74 are connected to the rack housing 72. Each pinion member 75 comprises a wheel member 76 and a set of pinion gears 77 on either side of the wheel member.

One or more electromagnets 81 are arranged above the pinion housing, and one or more corresponding magnetic members 80 are arranged on top of the pinion housing. The guide wire rope 66 runs through the locking device 70, in slits 78, 79.

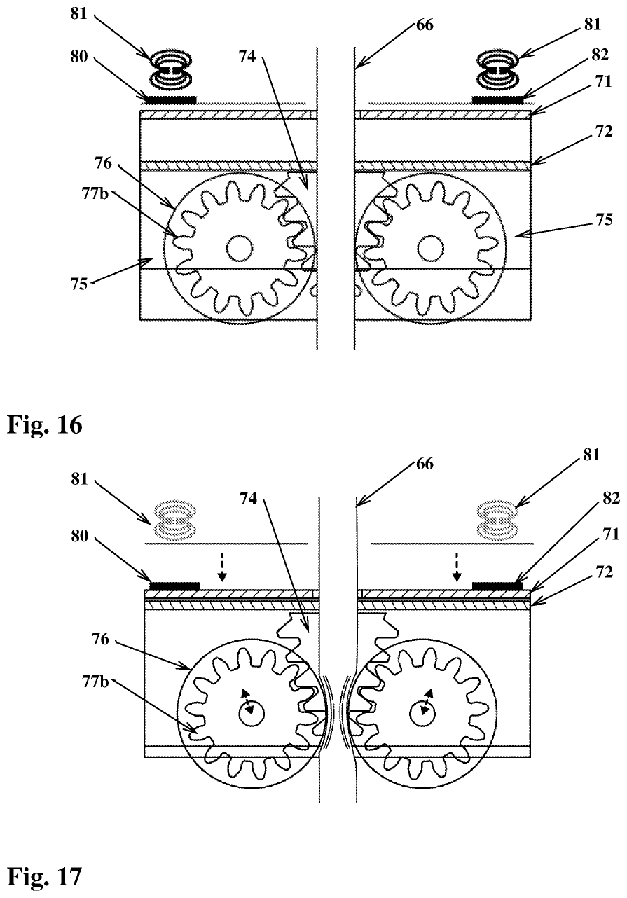

When the cage 1 is lifted, as it is not locked for lifting, and at least one electromagnet 81 is activated, the pinion housing 71, including the pinion member 75, is lifted. In this state, the cage is not attached to the guide wire rope 66 and may be moved (up or down), for example by means of the electricity and communication cable 67b mentioned above, or other line, cable or rope. This is illustrated in FIG. 16. The wheel member 76 may be made of steel, hard plastic or rubber, or any other suitable material. When the at least one electromagnet 81 is deactivated, the pinion housing will fall down and the wedge-shaped rack member 74 will force the two pinion members 75 towards each other and cause the respective wheel member 76 to bear against opposite sides of the guide wire rope 66, thus fixing the locking device 70 against the guide wire rope 66. This is illustrated in FIG. 17.

Although the locking device 70 has been described with reference to the embodiment of the invention illustrated in FIGS. 11 to 13 it should be understood that it may be used on the embodiment of the invention illustrated in FIGS. 1 and 2.

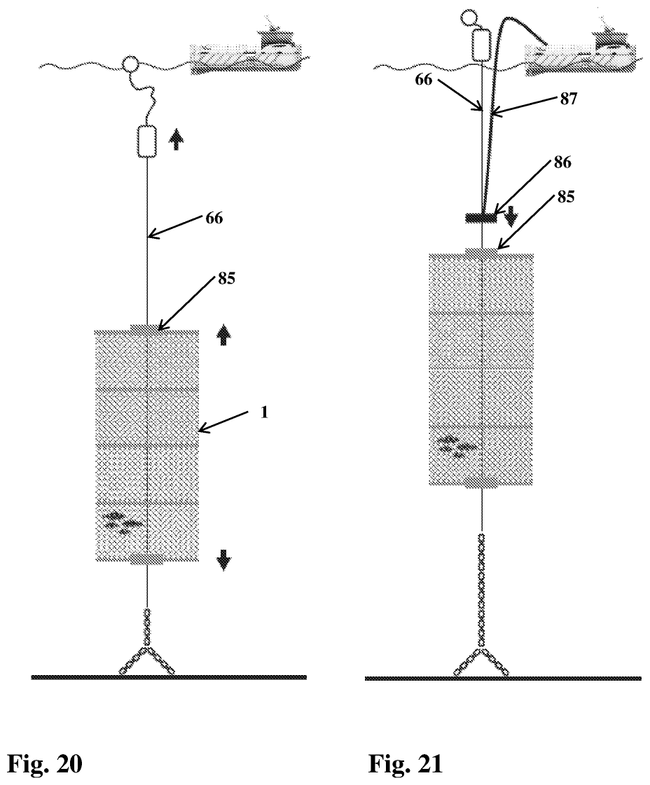

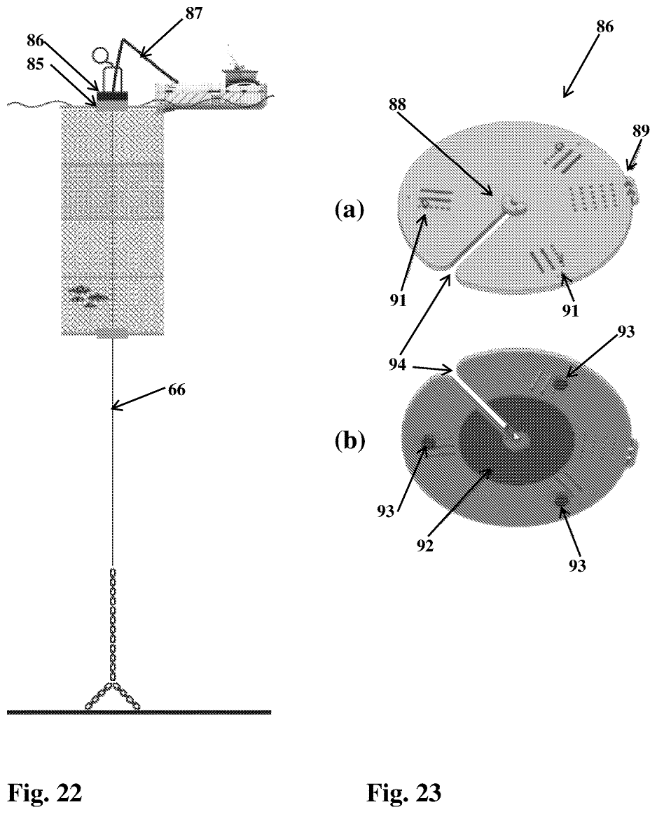

FIGS. 20, 21, and 22 illustrate yet another embodiment of the invented system, installed in a body of water, and an associated depth adjustment procedure. The cage 1 is movable (up and down) along the guide wire rope 66, the depth being controllable by buoyancy devices and/or weights. In one embodiment, the cage is neutrally buoyant. In this embodiment, depth adjustment is achieved by extending a support element 86 connected to a wire or cable 87 (for example an electric cable or a support rope), down to the cage. In the illustrated embodiment (see FIGS. 23a and 23b) the support element 86 comprises one or more electromagnets 93 that may be positioned in a number of locations 91, and the cage comprises a corresponding magnetic support member 85. A slit 94 and rope lock 88 are provided in the support element, configured for receiving the guide wire rope. Reference number 89 denotes an attachment interface for camera and lights, and reference number 92 denotes a mass (e.g. steel) for providing a required negative buoyancy to the support element.

1. A system for controlling the position of a submersible container in a body of water comprising:
said container;
a guide wire rope or equivalent elongate guide member, extending between a support device and a ballast element or anchor arranged on or near a seabed and wherein the container is configured for movement along the guide wire rope;
an elongate support member which at a first end is functionally connected to the container and configured for restricting vertical movement of the container, and at a second end is functionally connected to a support device, and
a control assembly for controlling the length of the elongate support member between the support device and the container.

2. The system of claim 1, wherein the control assembly comprises a support platform arranged on the support device and a stopper device releasably connected to the elongate support member, and the container and the stopper device are arranged at opposite sides of the support platform whereby the container is supported by the support device when the stopper device is supported by the support platform.

3. The system of claim 1, wherein the control assembly comprises:
a support platform arranged on the support device and a least one stopper device releasably or permanently connected to the elongate support member and wherein:
the support platform comprises a channel configured and dimensioned for allowing the elongate support member and the stopper device to pass, and
the support platform comprises a device configured for extension into and retraction from the channel, and the device is dimensioned and configured to prevent the stopper device from passing through the channel.

4. The system of claim 3, wherein the device comprises at least one plunger.

5. The system of claim 4, wherein the support platform comprises a magnetically operated solenoid configured for operating the at least one plunger, at least one magnetic sensor configured for sensing a magnetic field in the channel, and wherein the at least one stopper device comprises a magnetic material, and wherein the support platform is configured to operate the solenoid when the at least one sensor detects the presence of the at least one stopper device inside the channel.

6. The system of claim 5, wherein the support platform comprises a timer configured for controlling the operation of the solenoid.

7. The system of claim 1, wherein the elongate support member at the first end comprises a ballast member which is configured and arranged for releasable abutment against a portion of the container and the container has positive buoyancy.

8. The system of claim 1, wherein the container is a submersible fish cage having a net and upper and lower (6) support members and a plurality of intermediate members and an upper module.

9. The system of claim 1, wherein the elongate support member is a rope or wire or an electricity and communications cable

10. The system of claim 1, wherein the guide wire rope. extends beyond the support device and is connected to a surface buoy

11. The system of claim 1, wherein the elongate support member comprises a first portion and a second portion that are relaseably connectable via a connector arranged on a mooring rope.

12. The system of claim 1, further comprising:
a locking device located on the top or the bottom of the container and comprising a rack housing and a pinion housing wherein two pinion members are rotatably connected to the pinion housing and two wedge-shaped rack members are connected to the rack housing and each pinion member comprises a wheel member and a set of pinion gears on either side of the wheel member, wherein one or more electromagnets are arranged above the pinion housing, and one or more corresponding magnetic members are arranged on top of the pinion housing, and the guide wire rope runs through the locking device
wherein when the container is lifted and at least one electromagnet is activated, the pinion housing is lifted whereby the container is not attached to the guide wire rope and may be moved up or down along the guide wire rope, and
wherein when the at least one electromagnet is deactivated, the pinion housing is released from the track housing and is allowed to fall downwards such that the wedgeshaped rack member will force the two pinion members towards each other and cause the respective wheel member to bear against opposite sides of the guide wire rope and thus fixing the locking device against the guide wire rope.

13. A method of controlling the vertical position of a submersible container in a body of water, by means of the system as specified by claim 2, the method comprising:
lifting the stopper device so that it is not supported by the support platform
repositioning the stopper device on the elongate support member and
lowering the stopper device until it is supported by the support platform.

14. The method of claim 13, wherein the stopper device is lifted and lowered while attached to the elongate support member and the lifting and lowering is performed by a crane connected to the elongate support member.

15. A method of controlling the vertical position of a submersible container in a body of water by means of the system as specified by claim 1, the method comprising:
arranging the submersible container in a body of water and connecting it to the guide wire rope;
connecting a mooring rope between the support device or the guide wire rope in a vicinity of the support device and a surface support device or other surface facility;
connecting an electricity and communications connector to the mooring rope;
connecting a first elongate support member portion between a system module and the connector;
connecting a second elongate support member portion between the connector and the container;
disconnecting the second elongate support member portion from the connector and connecting it to the surface support device; and
raising or lowering the second elongate support member portion to control the vertical position of the container in the body of water.
